(19) United States
(12) Patent Application Publication
(10) Pub. No.: US 2005/0010603 A1
(43) Pub. Date: Jan. 13, 2005

(54) Display for Markush chemical structures

(76) Inventor: Andrew H. Berks, Suffern, NY (US)

Correspondence Address: MERCK AND CO INC, P O BOX 2000, RAHWAY, NJ, 070650907, US

(21) Appl. No.: 10/912,880

(22) Filed: Aug. 6, 2004

Related U.S. Application Data
(63) Continuation of application No. 09/999,403, filed on Oct. 31, 2001.

(51) Int. Cl. G06F 7/00

(52) U.S. Cl. 707/104.1

(57) ABSTRACT

A display for results of query chemical structures containing Markush chemical groupings, wherein a two-dimensional chemical structure the resulting Markush groupings in the results may be displayed in a multiplicity of colors, line styles, shadings, and combinations thereof, in the structure, wherein each separate Markush grouping and various Markush substituent thereof in the database results in an easy to understand manner.

### FIELD OF THE INVENTION

The present invention is directed to “topological” Markush searchable displays, wherein searchable databases are characterized as two-dimensional arrays that can be graphically represented as chemical structures.

### BACKGROUND OF THE INVENTION

The display of Markush chemical groupings is an important and complex aspect of chemical structure searching. Markush groupings are frequently incorporated into the claims of chemical patent applications, patents, publications, and prior art searching strategies. Markush chemical grouping arrangements also occur in other media, including chemistry journal articles, chemistry books, and representations of combinatorial chemistry libraries.

Generally, Markush chemical groupings are in the form of generic chemical structures, wherein one or more nodes of the representation of a chemical structure can be enumerated as two or more real possibilities. For example, a node in a Markush chemical structure may be described as “R¹”, and R¹ may be described as being equivalent to a halogen or lower alkyl group, i.e. fluorine, chlorine, bromine, iodine, methyl, ethyl, propyl, butyl, pentyl, or hexyl (unless lower alkyl is defined differently).

An important occurrence of Markush chemical groupings can be found in patents and chemistry-related publications. One feature of current U.S. patent practice regarding the listing of Markush chemical groupings provide that applicants are not required to actually prepare every possible embodiment of the Markush grouping in order to claim the same. To rationalize this caveat, it is theorized that certain chemical atoms or groupings of similar chemical and physical properties will predictably display similar features, e.g. bonding arrangements, reaction schemes, crystallinity, etc. Likewise, one of ordinary skill in the art, according to 35 U.S.C. §103(a), would have known that similar chemical atoms or groupings, wherein chemical and physical properties thereof are so similar that these atoms or groupings are classified similarly by chemical publications and considered to be equivalent. For example, a Markush grouping might statistically possess over 10,000 possible real structures, but a patent applicant might only specifically disclose and claim, for example, 100 actual compounds. Thus, the Markush grouping may be defined to represent predictable structures, but not necessarily all the possible structures. An important consideration therein is that a predictable aspect of a Markush grouping might be valid prior art against other patent applicants. Therefore, the effective searching of Markush chemical groupings for a particular chemical structure can be an important aspect of chemical database and prior art patent searches.

In order to meet the generally recognized need for prior art searching of Markush chemical structures, several different searchable Markush database systems have been developed. These systems, known as “topological” Markush searchable databases, are characterized as database records comprising two-dimensional chemical graphs representing chemical structures. To search the databases, a user creates a query representing a two-dimensional chemical graph of a. chemical structure, and the database search engine is able to parse the query, perform a search, and return a set of records matching the query.

To meet the generally recognized need for prior art searching of Markush chemical groupings, several different searchable Markush database systems have been developed and made commercially available. Examples of the systems are Merged Markush Service (“MMS”), available on the Questel online system, and Marpat, available on STN online system. Both of these systems use similar, yet problematic, methods of displaying database records following a search. Generally, a database record is displayed on a computer screen as a graph, wherein portions of the database record that overlap with the query are highlighted or emphasized in some way to indicate the portions of the database record that corresponds to the query. One problem with this type of system is that Markush chemical grouping records in these databases are often very sequential and complex, and interpretation thereof is not straightforward or simple. In search results having a plethora of hits, analyses of the results can be tedious as well as time consuming.

As an example of the problem with the prior art method of Markush grouping database displays, the typical Marpat and MMS displays of search results require the user to load and review multiple screens to completely visualize the Markush record. Upon completion of this process, the user is presented with a large amount of irrelevant data, thus increasing the difficulty of analyses.

### SUMMARY OF THE INVENTION

The present invention is a display for search results for Markush chemical structures in a searchable database of Markush chemical structures, wherein a query chemical graph is entered into the database search system, and a set of one or more database record Markush chemical structures is retrieved by the database search system, characterized as for each record to be displayed, a chemical structure representation of the query chemical structure is programmatically generated, wherein the Markush substituents of the database record Markush structure that correspond to the query structure are shown on the display structure in a multiplicity of colors, line colors, line styles, line shadings, or other distinctive features, so that each Markush substituent is clearly delineated in the display structure, and wherein a Markush analysis is provided in the display, and wherein a hit analysis formula is provided in the display.

### BRIEF DESCRIPTION OF THE DRAWINGS

The file of this patent contains at least one drawing executed in color. Copies of this patent with color drawings will be provided by the Patent and Trademark Office upon request and payment of the necessary fee.

The invention disclosed herein and the various embodiments thereof will be better understood by those skilled in the art after reviewing the specification in conjunction with the drawing wherein:

FIG. 1 is a graphical illustration of a Markush display showing the two-dimensional chemical structure, Markush analysis, and hit analysis formula for an embodiment of the invention;

FIG. 2a is a graphical illustration of a conventional MMS record for a database hit containing Markush groupings;

FIG. 2b is another graphical illustration of a conventional MMS database record for the database hit containing Markush groupings;

FIG. 3a is a graphical illustration of a Markush display showing in “color” the two-dimensional chemical structure, Markush analysis, and hit analysis formula for another embodiment of the invention;

FIG. 3b is a graphical illustration of a Markush display showing in “stylized lines” the two-dimensional chemical structure, Markush analysis, and hit analysis formula for another embodiment of the invention;

FIG. 5a is a graphical illustration of a conventional MMS query structure;

FIG. 5b is a graphical illustration of a conventional MMS database hit containing a hit analysis formula containing Markush groupings;

FIG. 5c is another graphical illustration of a conventional MMS record for a database hit further defining a Markush grouping;

FIG. 5d is a graphical illustration of a conventional MMS record for a database hit further defining a Markush grouping;

FIG. 5e is a graphical illustration of a conventional MMS record for a database hit further defining a Markush grouping;

FIG. 5f is a graphical illustration of a conventional MMS record for a database hit further defining a Markush grouping;

FIG. 5g is a graphical illustration of a conventional MMS record for a database hit further defining a Markush grouping; and

FIG. 5h is a graphical illustration of a conventional MMS record for a database hit further defining a Markush grouping.

### DETAILED DESCRIPTION OF THE INVENTION

For purposes of understanding the invention disclosed herein, certain terms and phrases may be defined different for the usual manner or further defined by the definitions provided herein. If not defined differently, the terms and phrase provided herein should be accorded the same meaning as generally understood by those skilled in the art.

“Chemical graph” is defined as a two-dimensional representation of a chemical structure, wherein bonds, atoms, and nodes are drawn graphically. Chemical graphs may be prepared by those skilled in the art or commercially available software to a connection table that can be used internally by searchable chemical structure databases or Markush chemical structure databases as a query or a database record.

“Chemical grouping” is defined as portions of a chemical structure, e.g. substituent, classified according to similar properties and characteristics. Typically, chemical compounds are classified according to similar physical and chemical properties.

“Color” is defined as a method of representing different background regions on paper or a computer screen, bonds, atoms, and nodes using different colors, different shades of the same color, certain colors together, and the like to characterize different bonds, atoms, and nodes from one another.

“Database hit” is defined as a database record that is part of a positive database search result.

“Hit term highlighting” is defined as a technique that visually emphasizes the specific features of a chemical structure and Markush groupings using colors, shadings, combinations of colors, line thickness and stylization, special characters.

“Hit analysis formula” is defined as an illustration of the relationship of G groups in a database record resulting in a database hit, wherein the representation of a tree-like, nesting relationship of G groups is presented, e.g. G0(G1, G2, G7(G12, G19)). In the previous G group example, G1, G2 and G7 are parts of G0, the parent structure; G12 and G19 make up G7. Generally, the ‘hit analysis formula’ will only reference a nesting formula that is relevant to the query chemical structure.

“Line style” is defined as a method of representing different bonds, atoms, and nodes using dashed lines, dotted lines, hashed lines, lines of varying thickness, and the like to represent components of chemical and Markush groupings.

“Markush chemical structure” is defined as a form of a generic two-dimensional, chemical structure or chemical graph, suitable for hit term highlighting, wherein one or more nodes representing Markush groupings may be enumerated as two or more real possibilities, i.e. Markush substituents. A Markush chemical structure is composed of Markush groupings and Parent groupings.

“Markush grouping” is defined as a portion of a Markush chemical structure distinguished by ‘hit term highlighting;’ it represents a grouping containing a plurality of similar substituents, e.g. propyl, butyl, pentyl, etc. as part of a Markush grouping “R¹” described elsewhere.

“Markush substituent” is defined as a group of two or more allowed substituents, fragments, or chemical groups, in a Markush grouping represented by a designated node, e.g. a substituent may be described as “R1”, where R1 may be described as being equivalent to a halogen or lower alkyl group, meaning fluorine, chlorine, bromine, iodine, methyl, ethyl, propyl, butyl, pentyl or hexyl (unless lower alkyl is defined differently); the two real possibilities being halogen and lower alkyl groups. A Markush grouping is composed of Markush substituents.

“Markush analysis” is defined as reference components describing the Markush substituents in a Markush structure or chemical graph, e.g., a notation describing “R1” as halogen or hydrogen, “R2” as oxygen or sulfur, and “R3” as alkyl, wherein each R group is a Markush grouping in the structure.

“Node” is defined as chemical atoms, or the intersection of two or more bonds of a chemical grouping, or the termination of a bond at a chemical grouping. In a Markush chemical structure or a database query, a node can be a generic group representing an enumerated list of possible chemical substituents, such as “chlorine, methyl, or amino,” or a node can be a generic group permitted in the database, such as an alkyl group.

“Parent grouping” is defined as non-Markush chemical grouping that are identical in the query chemical structure and a Markush chemical structure, e.g. Markush grouping. These substituents are generally represented in, but not limited to, the colors of “black” or “grey”. ‘Parent groupings’ in the Markush chemical structure may be superimposed or place upon the ‘parent groupings’ in the query chemical structure to easily view the locations of Markush groupings in the search results of the query chemical structure.

“Reference component” is defined as an individual Markush substituent utilized to further define a hit analysis formula, Markush analysis, and Markush chemical structure, e.g. G1, G2 . . . , and Gⁿ.

The invention provides a novel manner for visualizing the display of database record results in a Markush database. In this invention, the display of records in a Markush database search are matched to the query, rather than matching the query to a database record display. The invention is embodied by a display of valid database records, characterized by the generation of a two-dimensional structure containing a Markush chemical structure similar in appearance to the query structure, a hit analysis formula, and Markush analysis, wherein the display generation is performed programmatically by the display system of the searchable Markush database. Within the generated query structure for each valid database record matching the query, the various parts of the database record that resulted in that record being a valid hit against the query are displayed in a distinctive fashion, for example by the use of hit term highlighting, e.g. different colors, different line colors, different line styles, different shading, and the like. For example, the parts of the hit that match the parent Markush substituents in the Markush database record structure would be drawn in a “black” (assuming a white or contrasting background), and the parts of the hit that match a reference component, G1, for an “R¹” in the database hit record would be displayed in “red”, and other parts that match other reference components, e.g. G3 and G7 for R³ and R⁷ groups, respectively, in the database record would be in different colors, shades or line styles. In this fashion, the visualization of the database hit record is far more straightforward and easier to analyze than with conventional art displays.

One embodiment of the invention may be characterized as a display for search results for a query chemical structure, the query structure being searchable on a Markush chemical records database capable of providing Markush groupings in the search results, wherein a hit analysis formula provides a nesting arrangement of reference components, the display characterized as: Markush chemical structures comprising reference components, wherein each Markush chemical structure comprises parent groupings and Markush groupings, wherein the parent groupings of the Markush chemical structure are superimposable upon the parent groupings of the query chemical structure, wherein each Markush grouping corresponds to the hit analysis formula, wherein the hit analysis formula corresponds a Markush analysis, and wherein the reference components of the Markush groupings and Markush analysis correspond to a hit highlighting format. Optionally, the hit analysis formula, reference components may be in hit term highlighting that corresponds to that of the Markush analysis and Markush chemical structure. Optionally, the Markush substituent corresponding to the search query substituent may be underlined. Further, a ‘hit term highlighting’ format may be selected from stylized lines, colors, shades, patterns, and the like, or combinations thereof, and the reference component's names and hit term analysis for the Markush analysis correspond to that of the Markush groupings of the search results.

Generally, the Markush chemical structure is superimposable upon the query chemical structure. That is, after the query chemical structure has been represented according to the requirements of the database, the database hit may be displayed in a similar format and size, wherein the parent groupings of the Markush chemical structure may be placed upon or superimposed on the parent groupings of the non-Markush components of the query to further highlight the Markush groupings.

The Markush chemical structure will generally be depicted as having one or more Markush chemical groupings therein. The Markush chemical groupings are further defined as Markush substituents. The Markush substituents are chemical substituents exhibiting similar physical and chemical properties, e.g. methyl, ethyl, propyl, etc.

In another embodiment of the invention, the novel display may be characterized as a Markush chemical structure, a hit analysis formula, and a Markush analysis. Each of the Markush chemical structure, hit analysis formula, and Markush analysis may contain identical reference components, e.g. G1, G2, etc. The reference components may display ‘hit term highlighting’ that corresponds for all G1, G2, etc. of the display, i.e. all G1s may be characterized as “blue”, all G2s may be characterized as “green”, while the non-Markush components or parent groupings, for example, (that are identical in the query and Markush chemical structures) may be characterized as “black”.

Yet another embodiment of the invention provides a display of search results for a query chemical structure, the query structure being searchable on a Markush chemical records database capable of providing Markush groupings in the search results, wherein a hit analysis formula provides a nesting arrangement of reference components, the display characterized as: Markush chemical structures comprising reference components, wherein each Markush chemical structure comprises parent groupings and/or Markush groupings, wherein the parent groupings of the Markush chemical structure are superimposable upon the parent groupings of the query chemical structure, wherein each Markush grouping corresponds to the hit analysis formula, wherein the hit analysis formula corresponds a Markush analysis, and wherein the reference components of the Markush groupings and Markush analysis correspond to a hit term highlighting format, wherein the hit term highlighting format is selected from stylized lines, colors, shades, patterns, combinations thereof, and the like.

While still another embodiment of the present invention may be characterized as a display for search results for a query chemical structure, the query structure being searchable on a Markush chemical records database capable of providing Markush groupings in the search results, wherein a hit analysis formula provides a nesting arrangement of reference components, the display characterized as: means for programmatically, via computer and the like, generating chemical structures, each of which is a representation of the query chemical structure, characterized as Markush chemical structures comprising reference components, wherein each Markush chemical structure comprises parent groupings and/or Markush groupings, wherein the parent groupings of the Markush chemical structure are superimposable upon the parent groupings of the query chemical structure, wherein each Markush grouping corresponds to the hit analysis formula, and the Markush grouping comprises Markush substituents, wherein the reference components of the hit analysis formula corresponds to a Markush analysis, and wherein the reference components of the hit analysis formula, Markush groupings and Markush analysis correspond to a coordinated hit term highlighting format, wherein the hit term highlighting format is selected from stylized lines, colors, shades, patterns, and combinations thereof, and wherein Markush substituents that corresponds to the correspond to the query chemical structure are underlined.

In another embodiment of the invention, the novel Markush display provides hit term highlighting, i.e. corresponding color, line style, shading, and the like for reference components, e.g. G1, G2 . . . Gⁿ, in the chemical structure containing Markush groupings, hit analysis formula, and Markush analyses. The coordination of hit term highlighting in these reference components of the display provides an easy means of visualizing the nesting arrangement, and substitution of Markush groupings of the Markush grouping into the chemical structure.

Furthermore, another embodiment of the invention relates to a method of displaying search results for a query chemical structure, the query structure being searchable on a Markush chemical records database capable of providing Markush groupings in the search results, wherein a hit analysis formula provides a nesting arrangement of reference components, characterized as: a) displaying Markush chemical structures characterized as reference components, wherein each Markush chemical structure is characterized by parent groupings and Markush groupings; b) providing means in the display for superimposing parent groupings of the Markush chemical structure upon the parent groupings of the query chemical structure, wherein each Markush grouping corresponds to the hit analysis formula; c) providing means in the display where the reference components of the hit analysis formula corresponds a Markush analysis, and d) providing means in the display for corresponding the reference components of the hit analysis formula, Markush groupings and Markush analysis to a coordinated hit term highlighting format, wherein the hit term highlighting format is selected from stylized lines, colors, shades, patterns, and combinations thereof.

The examples provided below are for illustrative purposes only and in no way provide the only means of practicing the invention. Those skilled in the art will readily appreciate other methods of utilizing the display of Markush chemical structures of the invention.

### EXAMPLE 1

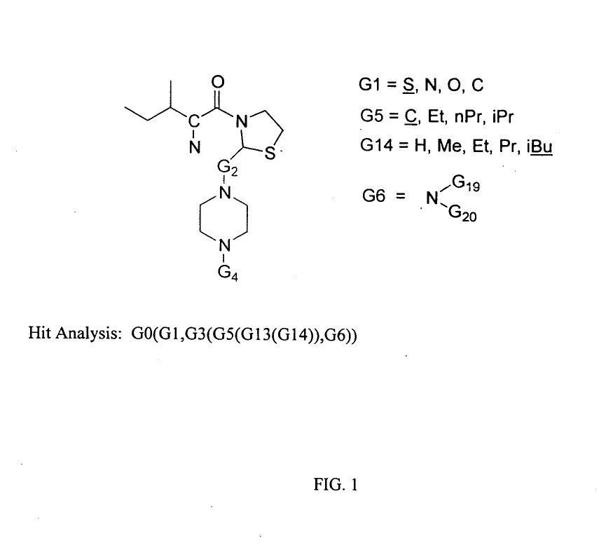

Example 1 is an illustration of a Markush database record display embodied in the invention, as adopted from CN9246-45901 (database access number) in MMS. The query chemical structure, wherein all possible sties are open for substitution, as follows: 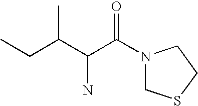
is searched in a known Markush database in accordance with conventional techniques. In accordance with the invention, the sites on the structure available for substitution may be designated by color codes, letter styles, shadings, sizes, combinations thereof, and the like. For instance referring to FIG. 1, a possible result of the search can be displayed as set forth therein. The search result provides a two-dimensional chemical graph, a nesting or hit analysis formula, and a set of Markush reference components matching the hit analysis components. The format, i.e. color, letter styles, shadings, etc. of the hit Markush reference components are characteristic of the nodes and atoms of the two-dimensional structure. The colors of the Markush reference components, G1 (“red”)=S, N, O, and C; G5 (“green”)=C, Et, nPr, and iPr; G14 (“purple”)=H, Me, Et, Pr, and iBu; and G6 (“blue”)=N(G¹⁹G²⁰), are characteristic of the colors of their matching Markush groupings, i.e. nodes and atoms, of the two-dimensional chemical graph. In one embodiment of the invention, the nodes and/or atoms of the Markush groupings that were provided in the query chemical structure are underlined in the listing provided in the search results. The complete listing of nodes and/or atoms for each Markush reference component are those found in the search results, while the “colored” nodes and/or atoms in the resulting two-dimensional chemical structure correspond to the color of the Markush reference component. Utilizing this formatting method, it is easy to identify the various ‘nodes’ and ‘elements’ of the Markush reference components and correspond it to a location in the two-dimensional chemical graph.

The above referenced hit analysis formula may be interpreted as G0 being the overall structure; G1 is linked to G3; G5 and G6 make up G3; G13 is a member of G5; and G14 is a member of G13. The nesting or hit analysis formula, conventional to conventional databases, is essential for interpreting the linking arrangement of the reference components to one another. In one embodiment of the invention, references components that are part of the resulting chemical records database search, but were not identified in the query chemical structure are not listed in the hit analysis formula or set of matching Markush reference components. The portion of the structure 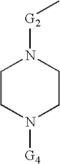
a parent grouping, is designated as “grey” nodes and bonds, and is part of the parent chemical structure but not present in the query. Although components G2 and G4 are shown in the resulting two-dimensional chemical structure, they are not referenced in the query chemical structure.

The color codes indicate which G group in the Markush record overlaps with the query structure. The bonds and atoms in “black”, parent groupings, are components of G0, the parent structure. The bonds and atoms in “grey” are part of G0 in the database, but not part of the query structure. In the database, G1 is S, N, O, or C, and this G group is coded “red,” so that the S in the display structure is displayed in “red” Lists enumerating substituents for the other relevant G groups are likewise provided, with G5 in “green,” G6 in “blue,” and G14 in “purple.”

### COMPARATIVE EXAMPLE 2

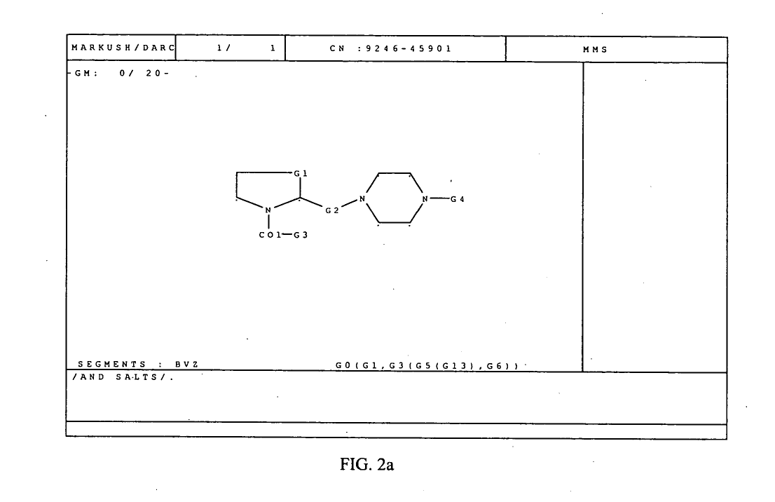

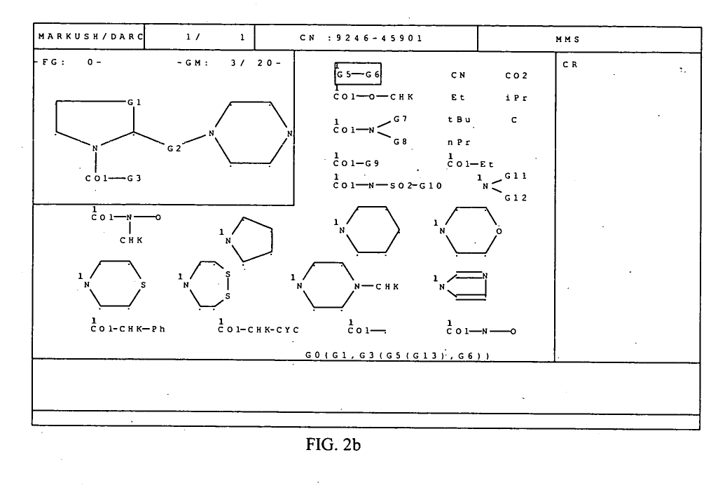

FIG. 2a illustrates the search results provided by a conventional MMS record displays corresponding to the structure of Example 1 (CN:9246-45901). Note that the overall, two-dimensional chemical structure, G0, is identical to the results of Example 1. Illustrated in FIG. 2, according to the hit analysis formula, is the parent record, G0, wherein each of G1, G3, G5, G13, and G6 as well as their nesting arrangement are noted. Also, the relevant Markush reference components, G1, G2, and G4 are shown in the chemical structure. In MMS, each G group of the nesting arrangement has its own screen, i.e. (G1, G3 . . . G6), other than search result displays relevant to the search query, additional MMS screens are not shown.

FIG. 2b illustrates the computer display for G0's substituent G3, which links to the parent group G0, wherein G0 is displayed in the box of the upper left corner. The superscript “1” in each fragment of the main field on the screen, enumerating allowed substitution at G3 (the “Markush substituents”), indicates the bonding site to G0 for the Markush substituents enumerated. Thus, the smaller box to the right of the G0 box indicates that G5-G6 are bonded at “1” to “CO”. This MMS display requires the user to load as many as 7 different screens to completely visualize all the Markush grouping of the record results. Note that G13 bonded to the amide carbonyl, and G5 is a Markush substituent of G3 that is bonded to G6. Markush groupings for G5-G6 are on other screens not shown. Note the numerous other irrelevant possibilities for G3.

### EXAMPLE 3

In this example, the query chemical structure is illustrated herein below: 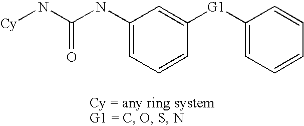
wherein “Cy” can be any ring system, and “G1” can be an atom selected from C, O, S, and N. This example was adopted from Marpat accession number 131:58658, WO 99/32436, Bayer Corporation.

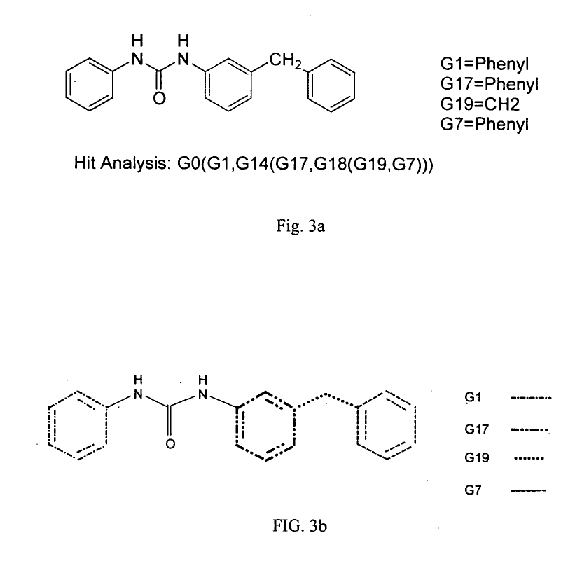

According to one embodiment of the present invention, the Markush database hit provides a two-dimensional chemical structure with hit term highlighting for Markush groupings, hit analysis formula, and hit analysis formula therefor as illustrated in FIG. 3a. Utilizing the Markush groupings, hit analysis formula, and Markush analysis together, as a method of display the database hit, it is generally easier to visualize and determine the relevance of the hit to the query structure. Portions of the resulting database record and Markush grouping reference components are ‘color coded’ to indicate the nodes and atoms of the query that fit the database record. Note that Cy of the query structure is G1 (“red”); the phenyl between “N” and “CH₂” is G17 (“green”); “CH₂” is G19 (“blue”); and the terminal phenyl is G7 (“pink”). Note that “N—(CO)—N” is not a Markush substituent.

In another embodiment of the invention, the ‘database hit’ and associated ‘hit term highlighting’ are characterized as “stylized line” in the two-dimensional chemical structure FIG. 3b. Note that the data base hit of FIG. 3b is identical to FIG. 3a. G1, G7, G9, and G17 are all relevant components of the parent group, G0, and are identical to the group components in FIG. 3a.

### COMPARATIVE EXAMPLE 4

This example provides an illustration of a conventional display taken from Marpat. The query chemical structure is identical to that of Example 3 herein above.

Marpat Query
L14 HAS NO ANSWERS
L14 STR

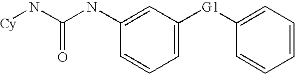

G1 C, O, S, N

Structure attributes must be viewed using STN Express query preparation.

Marpat Answer
L21 ANSWER 1 OF 3 MARPAT COPYRIGHT 2001 ACS

| ACCESION NUMBER: | | | 131:58658 MARPAT | |
|---|---|---|---|---|
| TITLE: | | | Inhibition of raf kinase using symmetrical and | |
| | | | unsymmetrical substituted diphenyl ureas | |
| INVENTOR(S): | | | Miller, Scott; Osterhout, Martin; Dumas, Jacques; | |
| | | | Khire, Uday; Lowinger, Timothy Bruno; Riedl, Bernd; | |
| | | | Scott, William J.; Smith, Roger A.; Wood, Jill E.; | |
| | | | Gunn, David; Rodriguez, Mareli; Wang, Ming | |
| PATENT ASSIGNEE(S): | | | Mayer Corporation, USA | |
| SOURCE: | | | PCT Int. Appl., 89 pp. | |
| | | | CODEN: PIXXD2 | |
| DOCUMENT TYPE: | | | Patent | |
| LANGUAGE: | | | English | |
| FAMILY ACC. NUM. COUNT: | | | 1 | |
| PATENT INFORMATION | | | | |
| PATENT NO. | KIND | DATE | APPLICATION NO. | DATE |
| WO 9932436 | A1 | 19990701 | WO 1998-US26081 | 19981222 |

W: AL, AM, AT, AU, AZ, BA, BB, BG, BR, BY, CA, CH, CN, CU, CZ, DE,
DK, EE, ES, FI, GB, GD, GE, GH, GM, HR, HU, ID, IL, IN, IS, JP,
KE, KG, KP, KR, KZ, LC, LK, LR, LS, LT, LU, LV, MD, MG, MK, MN,
MW, MX, NO, NZ, PL, PT, RO, RU, SD, SE, SG, SI, SK, SL, TJ, TM,
TR, TT, UA, UG, UZ, VN, YU, ZW, AM, AZ, BY, KG, KZ, MD, RU, TJ,

TM

| | |
|---|---|
| RW: | GH, GM, KE, LS, MW, SD, SZ, UG, ZW, AT, BE, CH, CY, DE, DK, ES, |
| | FI, FR, GB, GR, IE, IT, LU, MC, NL, PT, SE, BF, BJ, CF, CG, CI, |
| | CM, GA, GN, GW, ML, MR, NE, SN, TD, TG |

| | | | |
|---|---|---|---|
| AU 9919054 | A1 19990712 | AI 1999-19054 | 19981222 |
| EP 1049664 | A1 20001108 | EP 1998-963809 | 19981222 |

| | |
|---|---|
| R: | AT, BE, CH, DE, ES, FR, GB, GR, IT, LI, LU, NL, SE, MC, PT, |
| | IE, SI, LTY, LV, FI, RO |

| | | | | |
|---|---|---|---|---|
| NO 2000003230 | A | 20000821 | NO 2000-3230 | 20000621 |
| PRIORITY APPLN. INFO.: | | | US 1997-996344 | 19971222 |
| | | | WO 1998-US26081 | 19981222 |

MSTR 1

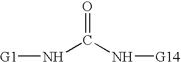

| | | |
|---|---|---|
| G1 | = | 5 / 22 / 82 / Cb<EC (9-) C, AR (1-), BD (6-) N, |
| | | RC (2-0), RS (0-) E6> (SO) / Hy<EC (6-) C, AR (1-), |
| | | BD (6-) N, RC (2-), RS (0-) E6> (SO) |

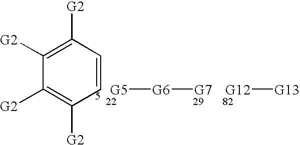

| | | |
|---|---|---|
| G2 | = | H / F / Cl / Br / I / NO2 / |
| | | alkyl<(1-10)> (SO (1-) G3) / alkoxy<(1-10)> (SO (1-) G3) / |
| | | aryl<(6-12)> (SO (1-) G4) / heteroaryl<(5-12)> (SO (1-) G4) / |
| | | (SC thienyl / pyrrolyl (SO Me) / CF3 / Bu-t) |
| G3 | = | F / Cl / Br / I |
| G4 | = | alkyl<(1-10)> / alkoxy<(1-10)> |
| G5 | = | phenylene (SO (-3) G8) |
| G6 | = | CH2 / S / NMe / 30-22 31-29 / 32-22 33-29 / |
| | | 34-22 35-2 / 37-22 36-29 / C(O) / O |

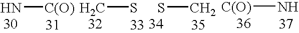

| | | |
|---|---|---|
| G7 | = | Ph (SO (1-) G9) / pyridyl (SO (1-) G10) / |
| | | naphthyl (SO (1-) G10) / 50 / pyrazinyl (SO (1-) G10) / |
| | | pyrimidinyl (SO (1-) G10) / quinolinyl (SO (1-) G10) / |
| | | benzothiazolyl (SO (1-) G10) / 54 / 63 / 79 / |
| | | Hy<EC (2) Q (2) O (0) OTHERQ (8) C, AR (1-), BD (6) N, |
| | | RC (2), RS (2) E6> (SO (1-) G10) |

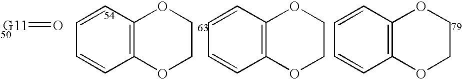

| | | |
|---|---|---|
| G8 | = | F / Cl Br / I / NO2 / alkyl<(1-10)> (SO (1-) G3) / |
| | | alkoxy<(1-10)> (SO (1-) G3) / aryl<(6-12)> (SO (1-) G4) / |
| | | heteroaryl<(5-12)> (SO (1-) G4) |
| G9 | = | alkyl<(1-10)> / alkoxy<(1-10)> / F / Cl / Br / I / |
| | | OH / SMe / NO2 / 40 |

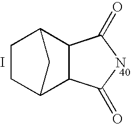

| | | |
|---|---|---|
| G10 | = | alkyl<(1-10)> / alkoxy<(1-10)> / F / Cl / Br / I / |
| | | OH / SMe / NO2 |
| G11 | = | Hy<EC (1) Q (1) N (0) OTHERQ (5) C, AR (0), |
| | | BD (2) D, RC (1), RS (1) E6> (SO (1-) G10) |
| G12 | = | phenylene (SO (-3) G8) |
| G13 | = | pyridyl (SO (1-) G10) |
| G14 | = | 112 / 131 / 95 / 92 / 105 / 144 / |
| | | Cb<Ec (9-) C, AR (1-), BD (6-) N, RC (2-), RS (0-) E6> (SO) / |
| | | Hy<Ec (6-) C, AR (1-), BD (6-) N, RC (2-), RS (0-) E6> (SO) |

| | | | |
|---|---|---|---|
| 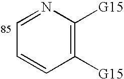 | 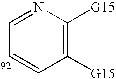 | 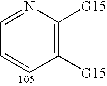 | 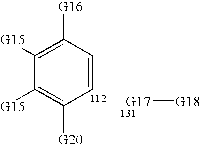 |
| 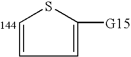 | | | |

| | | |
|---|---|---|
| G15 | = | H / F / Cl / Br / I / alkyl<(1-10)> (SO (1-) G3) / |
| | | 120 / 126 / alkoxy<(1-10)> (SO (1-) G3) |

| | |
|---|---|
| 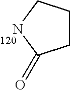 | 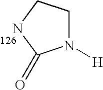 |

| | | |
|---|---|---|
| G16 | = | H / F / Cl / Br / I / alkyl<(1-10)> (SO (1-) G3) / |
| | | alkoxy<(1-10)> (SO (1-) G3) / (SC Me / CF3) |
| G17 | = | phenylene (SO (-3) G15) |
| G18 | = | 133 / pyridyl (SO (1-) G10) |

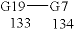

| | | |
|---|---|---|
| G19 | = | CH2 / S / NMe / 135-131 136-134 / 137-131 138-134 / |
| | | 139-131 140-134 / 142-131 141-134 / C(O) / O |

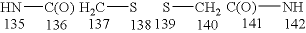

| | | |
|---|---|---|
| G20 | = | H / F / Cl / Br / I / alkyl<(1-10)> (SO (1-) G3) / |
| | | 151 / 157 / alkoxy<(1-10)> (SO (1-) G3) / |
| | | alkylcarbonylamino<(1-10)> (SO (1-) G3) / 162 / NO2 / |
| | | (SC Me / CF3 / OMe) |

| | | |
|---|---|---|
| 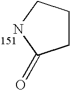 | 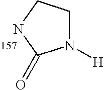 | 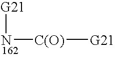 |

| | | |
|---|---|---|
| G21 | = | alkyl<1-10)> (SO (1-) G3) |
| DER: | | and pharmaceutically acceptable salts |
| MPL: | | claim 1 |
| NTE: | | substitution is restricted |
| NTE: | | also incorporates claim 15 |

Note the complexity of the Marpat answer display. The query structure is depicted as L14, wherein Cy is identical to that of Example 3, as is G1 and the atoms thereof. The Marpat answer, L21 provides 3 hit analyses, one of which is provided herein. The U.S. copyrighted hit analysis record for query chemical structure provides patent bibliographic information relative to U.S. patent and Patent Cooperation Treaty applications.

The database hit record is provided as the two-dimensional structure ‘MSTR 1,’ wherein components G1 and G14 are Markush groupings therein. The Markush grouping G1 may be further defined as the aryl substituent containing G2 bonding at 5, the linear substituent containing G5, G6, and G7, and the linear structure containing G12, and G13. Thereafter, the previously mentioned components are provided chemical substituents. The G14 component is further defined as G15, G16, G17, and G18 and the chemical substituents therefor are provided therefor.

Note that as more sub G components are defined for the principal G components, the identifying the relevance of the hit query chemical structure becomes more difficult. For example, G19 is highlighted in this Marpat record as ‘CH2.’ However, it is not clear form reviewing this record exactly how G19 fits into the hit. It appears that G19 is part of G18; in turn G18 is part of G14, which is linked to Markush substituent 131, which is G17 and G18 joined by a bond. Furthermore, the G component data like “alkyl<(1-10)>(SO(1-)G3 ” can be confusing.

### COMPARATIVE EXAMPLE 5

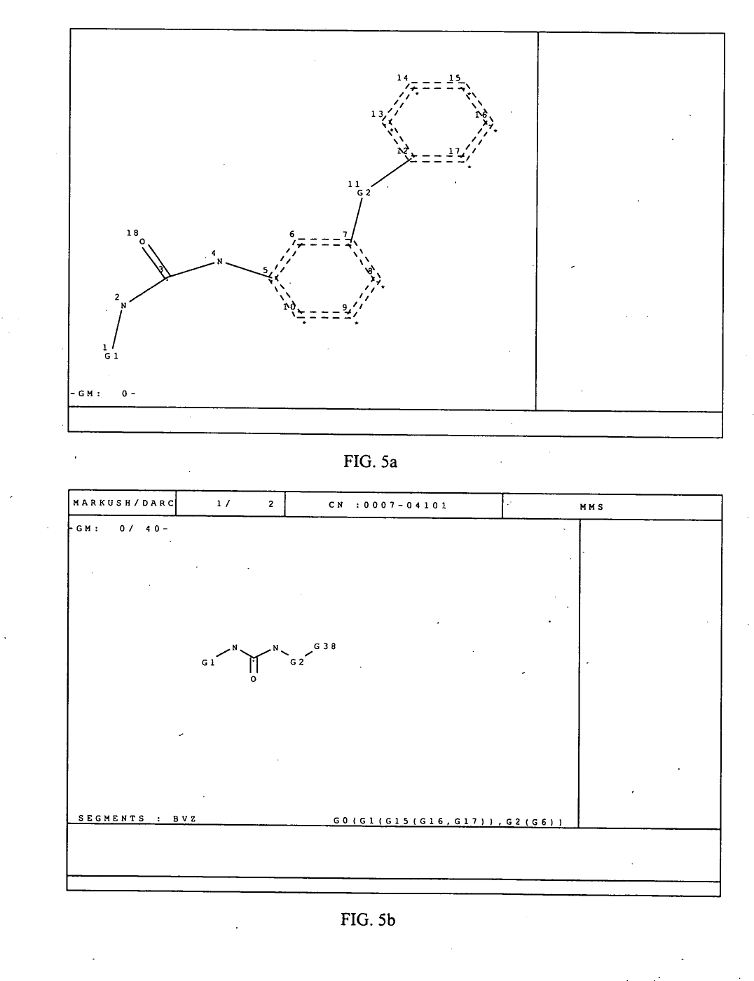

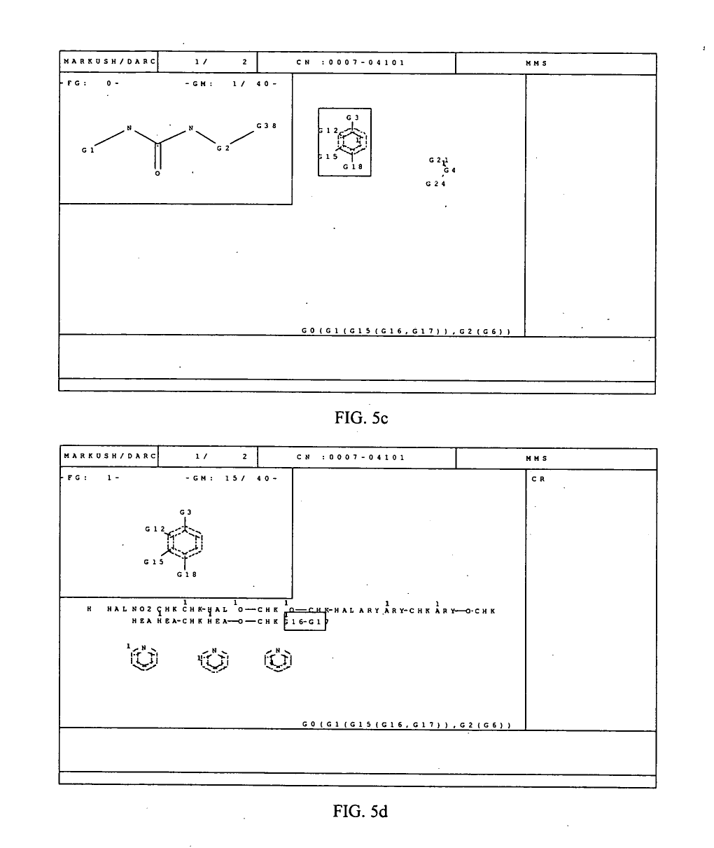

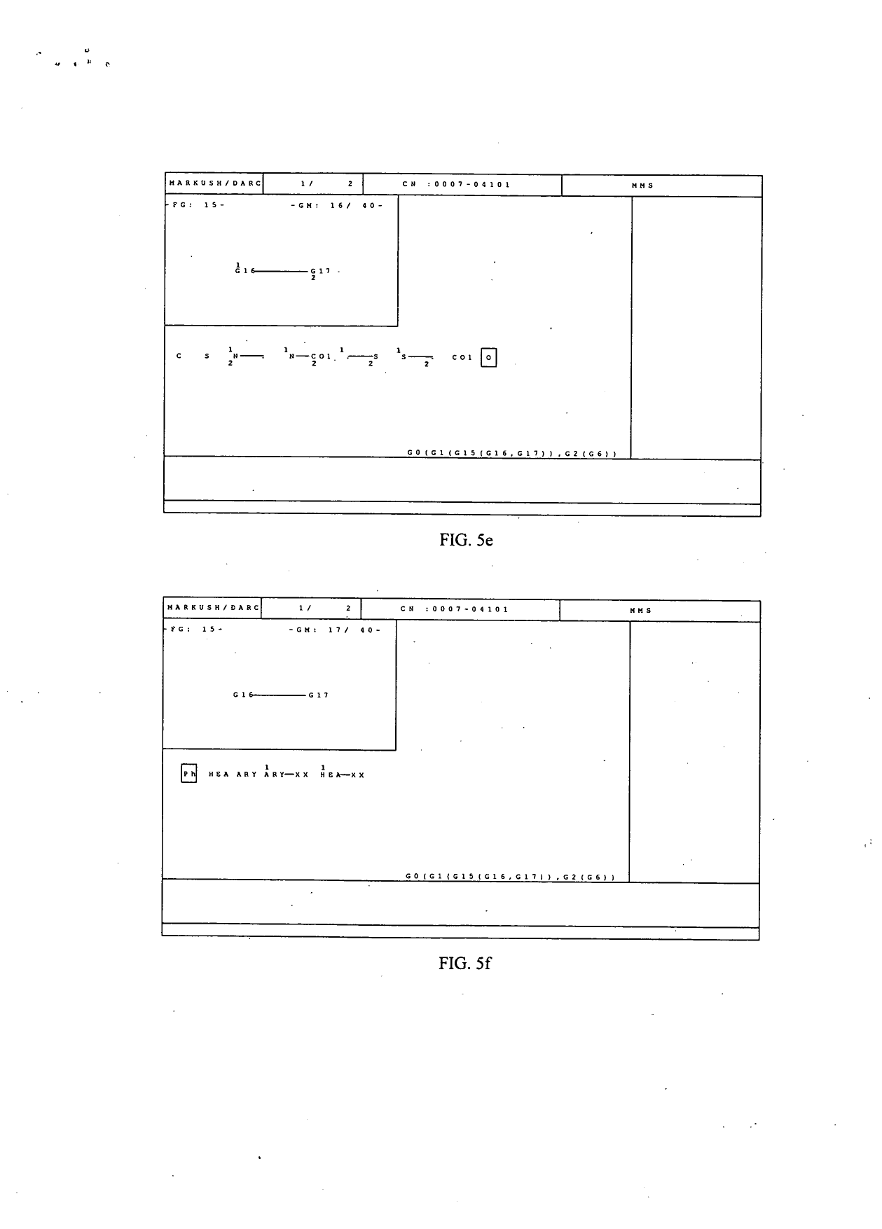

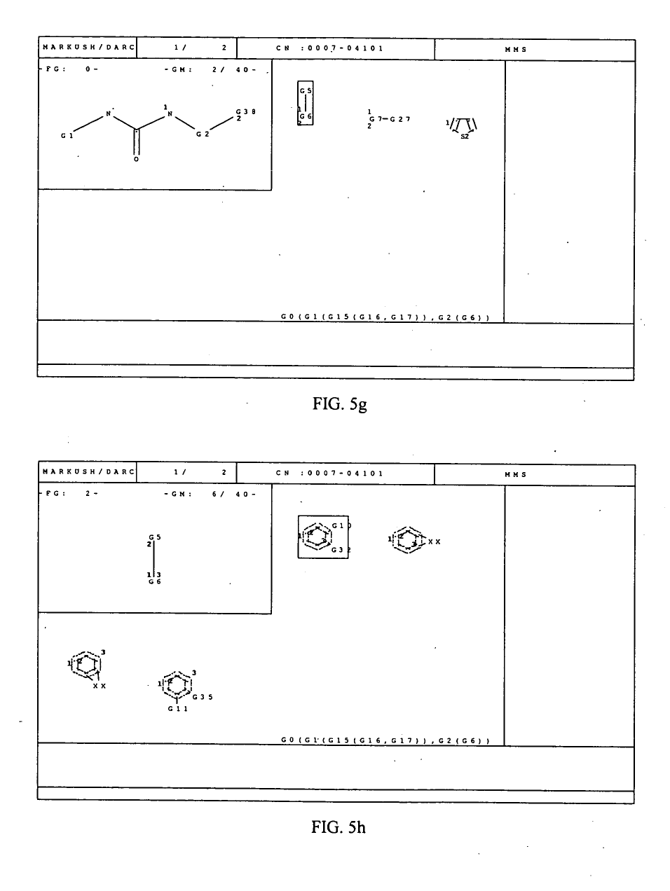

This example provides an MMS record for the same query chemical structure of Example 3. FIG. 5a provides the MMS query chemical structure. Note that “N—(CO)—N” of the query structure is not a Markush substituent. FIG. 5b provides the parent record G0 two-dimensional chemical structure and the hit analysis formula therefor. The chemical structure illustrates that G1, G2, and G38 are components thereof. FIG. 5c provides the database record for Markush grouping component G1. The relevant Markush grouping for G1 is enclosed in the ‘box of the figure, and the hit analysis formula is provided for G0; the Markush grouping referencing G21, G4 and G24 appears to be non-relevant to the answer. FIG. 5d provides the database record for Markush grouping component G15, a component of the aryl G1. The relevant component for G15 (inside the box) is further defined as G16-G17. FIG. 5e provides the database record for Markush grouping component G16. Of the Markush groupings provided for G15, oxygen, “O” appears to be a relevant answer for G15. FIG. 5f provides the database record for Markush grouping component G17, wherein the relevant answer appears to be ‘Ph,’ a phenyl group. FIG. 5g provides the database record for Markush grouping component G2. The G0 chemical structure is provided illustrating the location of G2 therein. The relevant answer for G2 appears in the box as linear substituent G5-G6, wherein the points of linkage are 2 and 1. FIG. 5h provides a definition for G6, wherein the relevant answer is shown in the box as an aromatic substituent containing G10 and G33, wherein the linkage points 2, 1 and 3 are provided. For each figure provided, a separate display must be viewed to examine every possible relevant Markush grouping.

1. A display for search results for Markush chemical structures in a searchable database of Markush chemical structures, wherein a query chemical graph is entered into the database search system, and a set of one or more database record Markush chemical structures is retrieved by the database search system, comprising:
for each record to be displayed, a chemical structure representation of the query chemical structure is programmatically generated, wherein the Markush substituents of the database record Markush structure that correspond to the query structure are shown on the display structure in a multiplicity of colors, line colors, line styles, line shadings, or other distinctive features, so that each Markush substituent is clearly delineated in the display structure, and wherein a Markush analysis is provided in the display, and wherein a hit analysis formula is provided in the display.

2. A display for search results for a query chemical structure, the query structure being searchable on a Markush chemical records database capable of providing Markush groupings in the search results, wherein a hit analysis formula provides a nesting arrangement of reference components, the display comprising:
Markush chemical structures comprising reference components, wherein each Markush chemical structure comprises parent groupings and Markush groupings, wherein the parent groupings of the Markush chemical structure are superimposable upon the parent groupings of the query chemical structure, wherein each Markush grouping corresponds to the hit analysis formula, wherein the hit analysis formula corresponds to a Markush analysis, and wherein the reference components of the Markush groupings and Markush analysis correspond to a hit highlighting format.

3. The display according to claim 2, wherein the hit highlighting format is selected from stylized lines, colors, shades, patterns, or combinations thereof, and wherein the Markush analysis corresponds to the Markush groupings of the search results.

4. The display according to claim 3, wherein the highlighting format is a multiplicity of colors.

5. The display according to claim 3, wherein the highlighting format is a multiplicity of line styles.

6. The display according to claim 3, wherein the highlighting format is a multiplicity of shadings.

7. The display according to claim 3, wherein the highlighting format of the Markush grouping is a combination of colors, line styles and shadings.

8. The display according to claim 3, wherein the Markush analysis comprises reference components of the search results.

9. The display according to claim 8, wherein the reference components comprise chemical substituents of the grouping.

10. The display according to claim 9, wherein the reference components of the search result Markush groupings and Markush analyses comprise corresponding highlighting formats.

11. The display according to claim 10, wherein the Markush analysis comprises reference components.

12. A display for search results for a query chemical structure, the query structure being searchable on a Markush chemical records database capable of providing Markush groupings in the search results, wherein a hit analysis formula provides a nesting arrangement of reference components, the display comprising:
Markush chemical structures comprising reference components, wherein each Markush chemical structure comprises parent groupings and Markush groupings, wherein the parent groupings of the Markush chemical structure are superimposable upon the parent groupings of the query chemical structure, wherein each Markush grouping corresponds to the hit analysis formula, wherein the hit analysis formula corresponds to a Markush analysis, and wherein the reference components of the Markush groupings and Markush analysis correspond to a coordinated hit term highlighting format, wherein the hit term highlighting format is selected from stylized lines, colors, shades, patterns, or combinations thereof.

13. The display according to claim 12, wherein the coordinated highlighting format is selected from colors and stylized lines.

14. The display according to claim 13, wherein the coordinated highlighting format is colors.

15. The display according to claim 14, wherein the reference components of the Markush analysis and Markush groupings in the search results are color coordinated, highlighting format.

16. The display according to claim 15, wherein the colors are identical for like reference components.

17. A display for search results for a query chemical structure, the query structure being searchable on a Markush chemical records database capable of providing Markush groupings in the search results, wherein a hit analysis formula provides a nesting arrangement of reference components, the display comprising: means for programmically generating chemical structures, each of which is a representation of the query chemical structure, comprising Markush chemical structures comprising reference components, wherein each Markush chemical structure comprises parent groupings and Markush groupings, wherein the parent groupings of the Markush chemical structure are superimposable upon the parent groupings of the query chemical structure, wherein each Markush grouping corresponds to the hit analysis formula, wherein the reference components of the hit analysis formula corresponds a Markush analysis, and wherein the reference components of the hit analysis formula, Markush groupings and Markush analysis correspond to a coordinated hit term highlighting format, wherein the hit term highlighting format is selected from stylized lines, colors, shades, patterns, and combinations thereof, and wherein Markush substituents that corresponds to the correspond to the query chemical structure are underlined.

18. A method of displaying search results for a query chemical structure, the query structure being searchable on a Markush chemical records database capable of providing Markush groupings in the search results, wherein a hit analysis formula provides a nesting arrangement of reference components, the method comprising:
a. displaying Markush chemical structures comprising reference components, wherein each Markush chemical structure comprises parent groupings and Markush groupings;
b. providing means in the display for superimposing parent groupings of the Markush chemical structure upon the parent groupings of the query chemical structure, wherein each Markush grouping corresponds to the hit analysis formula;
c. providing means in the display where the reference components of the hit analysis formula corresponds a Markush analysis; and
d. providing means in the display for corresponding the reference components of the hit analysis formula, Markush groupings and Markush analysis to a coordinated hit term highlighting format, wherein the hit term highlighting format is selected from stylized lines, colors, shades, patterns, and combinations thereof.
